(19) United States
(12) Patent Application Publication
(10) Pub. No.: US 2004/0001342 A1
(43) Pub. Date: Jan. 1, 2004

(54) Collapsible lamp shade structure

(76) Inventor: Hsih Bin Chou, Dong-Guan City (CN)

Correspondence Address: LAWRENCE N. GINSBERG, 21 SAN ANTONIO, NEWPORT BEACH, CA, 92660-9112, US

(21) Appl. No.: 10/412,098

(22) Filed: Apr. 11, 2003

Related U.S. Application Data
(63) Continuation-in-part of application No. 10/126,023, filed on Apr. 19, 2002.
Application No. 10/126,023 is a continuation-in-part of application No. 10/010,131, filed on Dec. 6, 2001, now abandoned.
Application No. 10/126,023 is a continuation-in-part of application No. 10/040,979, filed on Oct. 19, 2001, now abandoned.

(51) Int. Cl. F21V 1/06

(52) U.S. Cl. 362/352

(57) ABSTRACT

A collapsible lamp shade includes a rigid upper structure assembly; a rigid lower structure; a flexible fabric; and, a plurality of plurality of trapezoidal frames. The rigid upper structure assembly includes a rigid upper structure; a plurality of angled arms extending radially inwardly from the rigid upper structure; and a central element. Each angled arm has a first end and a second end. The central element is positioned at a central portion of the rigid upper structure assembly. It secures the first ends of the plurality of angled arms. The second ends of the angled arms have short columns being secured to the rigid upper structure. The short columns are angled upwardly. The flexible fabric joins the rigid upper structure with the rigid lower structure. Each trapezoidal frame has a top parallel edge and a bottom parallel edge. The top parallel edge and bottom parallel edge are joined by side members. The top parallel edge has a notch formed in a section thereof. Users engage the notch with the short column of each angled radial arm when assembling the lamp shade such that the top parallel edge of the trapezoidal frame is positioned under the rigid upper structure.

### CROSS REFERENCE TO RELATED APPLICATIONS

This application is a continuation-in-part of U.S. Ser. No. 10/126,023, entitled Collapsible Lampshade Structure, filed on Apr. 19, 2002, which is a continuation-in-part of U.S. Ser. No. 10/010,131, entitled Collapsible Lampshade Structure, filed on Dec. 6, 2001, and is a continuation-in-part of U.S. Ser. No. 10/040,979, entitled Collapsible Lampshade Structure, filed on Oct. 19, 2001.

### BACKGROUND OF THE INVENTION

1. Field of the Invention

This invention relates to lamp shade structures and more particularly to an easily collapsible lamp shade structure that can be easily assembled.

2. Description of the Related Art

Traditional lamp shade structures are constructed from rigid frames surrounded in fabric. The standard lamp shade is made from an upper ring and lower ring connected by rigid fabric or by flexible fabric held with supporting rods. The supporting rods usually accept a compression force. The flexible fabric usually accepts a tensile force. The construction of a lamp shade having supporting rods requires the rods to be connected to the fabric. The fabric is sometimes sewn around the rod. Because the structure comprising the fabric, surrounding rods and frame are constructed as a unit, the lamp shade requires substantial volume. The lamp shade is also usually packaged in a transparent plastic bag, further adding volume.

One method of transporting lamp shades requires stacking the lamp shades. Unfortunately stacking is not possible when shipping individual lamp shades. Lamp shades stacked in bulk cannot be packaged with their respective lamps.

U.S. Pat. No. 6,443,599, entitled Lamp Cover Structure For Easy Assembly, issued to W. C. Wu, discloses a lamp cover structure for assembly having a top ring with radial support bars, a bottom ring, of which the perimeter is greater than that of the top ring, and a support frame connecting the top ring and the bottom ring. Ends of the support bars are folded inward to form clip hooks. Upper transversal arch bars of the support frame have concave clip grooves bent downward to engage the clip hooks. The bottom ring has inwardly inclined support bars engaged by the support frame to constrain movement of the support frame.

With the required clip hook/clip groove engagement required by Wu the upper transversal arch bars are positioned inside of the top ring. Thus, there is a resultant visual deficiency in viewing the lamp shade from the top. Furthermore, because of this arrangement, the vertical arch bars become spaced from fabric material of the lamp shade. This provides impediments in providing a variety of shapes desired by the manufacturer.

### SUMMARY

The present invention is a collapsible lamp shade that includes, in a broad aspect, a rigid upper structure assembly; a rigid lower structure; a flexible fabric; and, a plurality of plurality of trapezoidal frames. The rigid upper structure assembly includes a rigid upper structure; a plurality of angled arms extending radially inwardly from the rigid upper structure; and a central element. Each angled arm has a first end and a second end. The central element is positioned at a central portion of the rigid upper structure assembly. It secures the first ends of the plurality of angled arms. The second ends of the angled arms have short columns being secured to the rigid upper structure. The short columns are angled upwardly. The flexible fabric joins the rigid upper structure with the rigid lower structure. Each trapezoidal frame has a top parallel edge and a bottom parallel edge. The top parallel edge and bottom parallel edge are joined by side members. The top parallel edge has a notch formed in a section thereof. Users engage the notch with the short column of each angled radial arm when assembling the lamp shade such that the top parallel edge of the trapezoidal frame is positioned under the rigid upper structure.

Prior to assembly the lamp shade is collapsed to conserve storage space. After assembly the lamp shade may once again be collapsed for convenient storage.

As mentioned, upon assembly the top parallel edge of the trapezoidal frame is positioned under the rigid upper structure and thus hidden to enhance the visual effect. The provision of the upwardly angled short columns and their insertion into a notch provided in the top parallel edge of the trapezoidal frame provides this ability. With the device of the Wu reference, the arch bar of Wu's device is positioned to the side of the top ring. It is not hidden from view.

Furthermore, in the present invention since the top parallel edge of the trapezoidal frame is positioned under the rigid upper structure, the fabric material is adjacent to the sides of the trapezoidal frame. This provides enhanced support of the fabric material. In the Wu device, on the other hand, vertical arch bars are spaced from the fabric. The present invention thus provides greater flexibility in allowing the manufacturer to present the specific look that he desires. It provides for varying shapes.

In assembly of the present invention, the user positions the top parallel edge of the trapezoidal frame so that the notch therein engages the short column. Then, the bottom parallel edge of the trapezoidal frame is positioned between lower structure protrusions and the edge where the flexible fabric is connected to the rigid lower structure.

In assembly of the Wu device the user positions the bottom parallel edge and the lower structure as a first step. At this point the clip hook is near the center of the top ring. The clip hook is then slid in an outwardly radial direction until it engages a concave clip groove. Thus, the present invention is assembled in an entirely different manner than the Wu device.

### BRIEF DESCRIPTION OF THE DRAWINGS

FIG. 1 is a simplified schematic perspective view of a lamp shade showing some of its salient features.

FIG. 2 is a perspective view of a portion of a rigid upper structure of a first embodiment of the present invention which utilizes a notch located on the rigid upper structure.

FIG. 3 is a perspective view of a trapezoidal frame that can be utilized with that first embodiment.

FIG. 4 is a simplified schematic cutaway perspective view of the trapezoidal frame positioned in place in the lamp shade.

FIG. 5 is perspective illustration of a second embodiment in which angled radial arms are utilized, with the fabric material removed for the purposes of clarity.

FIG. 6 is a side view of the FIG. 5 embodiment.

FIG. 7 is a perspective view of a trapezoidal frame of the FIG. 6 embodiment, showing the use of a center notch therein.

FIG. 8 is a perspective view of another embodiment, also using a center notch, the radial arms being modified to provide a v-shape.

FIG. 8A is an enlarged perspective view of an upper section of a trapezoidal frame.

FIG. 8B is a section taken along line 8B-8B of FIG. 8.

FIG. 9 is a top view of the embodiment of FIG. 8.

FIG. 10 is a bottom view of the embodiment of FIG. 8.

FIGS. 10a-10d are schematic illustrations of lamp shades showing how the inventive features herein provide various shapes.

### DETAILED DESCRIPTION OF THE INVENTION

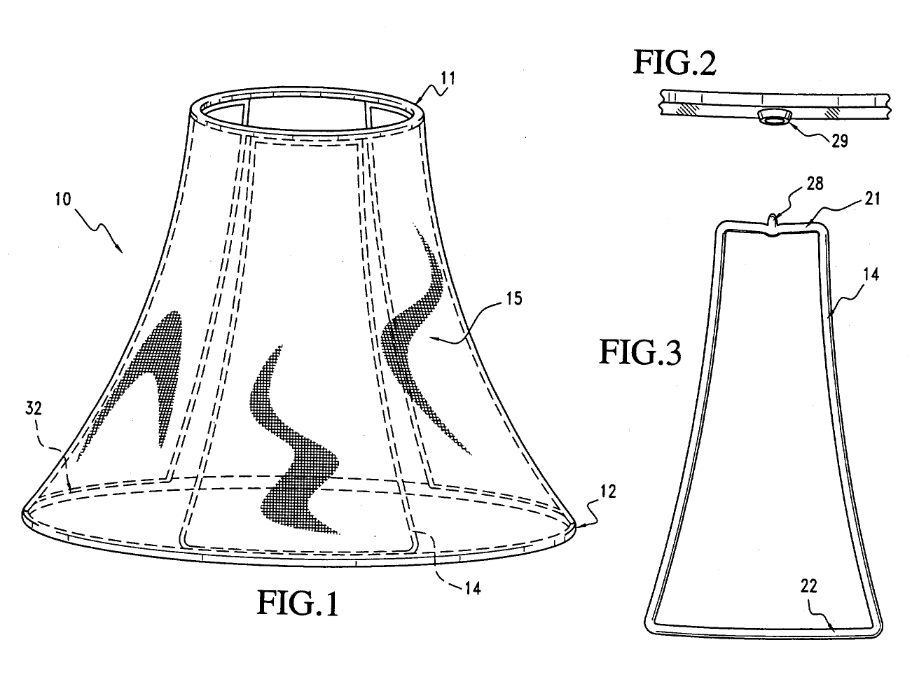

A collapsible lamp shade can conserve shipping volume and thus reduce the cost of doing business. The embodiment of the present invention, shown in FIGS. 1-4, designated generally as 10, comprises an upper rigid structure 11 connected to a lower rigid structure 12 by fabric 15 and supported by a plurality of basically trapezoidal frames 14.

When a lamp shade is cylindrical in shape, the rigid upper structure 11 and rigid lower structure 12 are flat metal rings attached to the fabric 15 by wrapping the fabric circumferentially about the rigid rings 11, 12. The fabric can be sewn or glued around the ring allowing retention of the fabric in a direction perpendicular to the surface of the ring.

Supporting trapezoidal frame members 14 inserted between the upper rigid structure 11 and lower rigid structure 12 provides rigidity to the shade. The frames act as ribs accepting a compressive force against the tensile force of the lamp fabric. Sometimes the tensile force can flexibly bend the trapezoidal frames to allow various artistic designs. Such artistic bending depends on the rigidity of the material used, such as plastic, rubber or bamboo, in the trapezoidal frame members 14.

Assembly of the lamp shade begins by opening the lamp shade and separating the upper and lower rigid structures 11 and 12. In a preferred embodiment, the two rigid structures 11 and 12 would be joined together by fabric 15 already affixed to them.

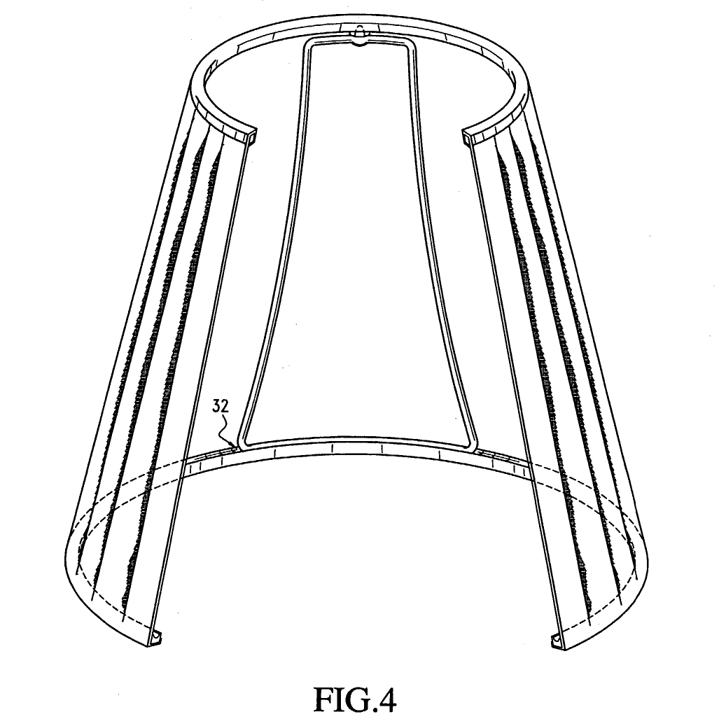

The trapezoidal frames 14 are then individually put into position to prop up the fabric 15 joining the two rigid structures 11 and 12. As can be seen in FIG. 3, in the mid section of a top parallel edge 21 of any trapezoidal frame 14, there is a dowel 28 pointing away from the frame 14. For each trapezoidal frame 14, the user inserts a dowel 28 into a notch 29 located on the upper rigid structure 11. The user then inserts a bottom parallel edge 22 into the groove 32 located at the lower rigid structure.

The groove 32 for receiving a bottom parallel edge 22 of any trapezoidal frame 14 can be formed by the gap between the lower rigid structure 12 and the fabric 15 when they were joined by gluing, sewing or other means. Alternatively, groove 32 may also be formed by cutting away a partial top portion along the circumferential length of lower rigid structure 12.

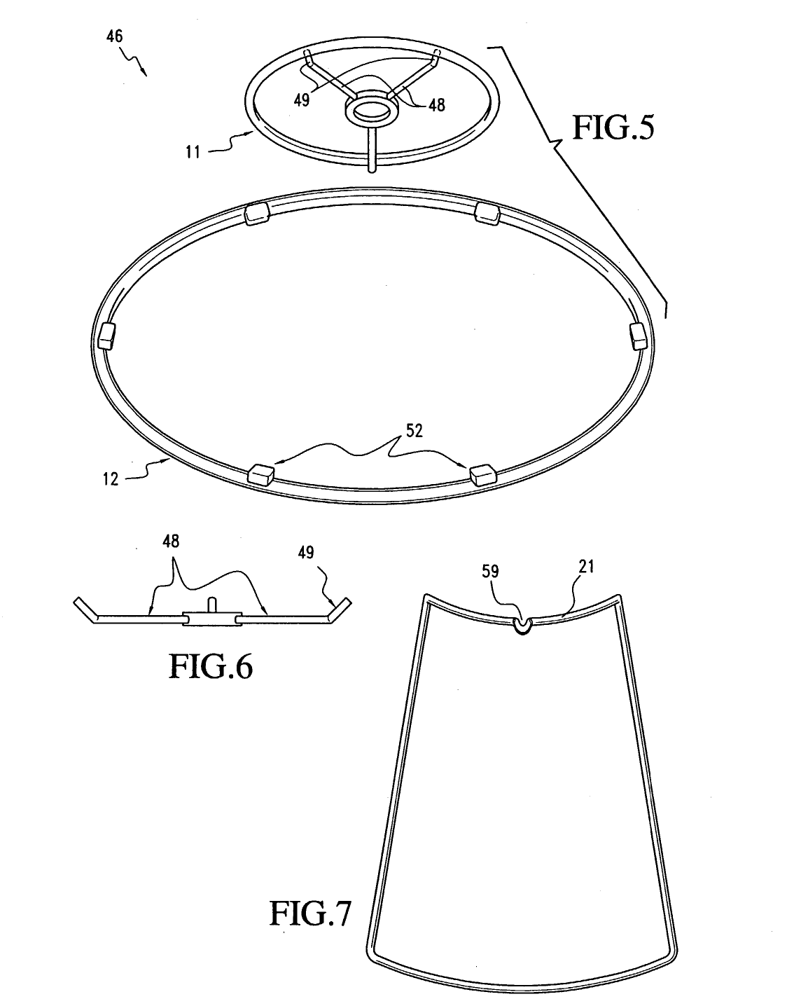

Referring now to FIGS. 5-7 another embodiment of the collapsible lamp shade, designated generally as 46, is illustrated. In this embodiment, the invention is implemented by having a plurality of angled arms 48 radially connected to the rigid upper structure 11 of a rigid upper structure assembly. As can be best seen in FIG. 6, each of the angled arms 48 has a short column 49 at the end that is connected to the rigid upper structure 11.

When assembling the lamp shade, users can fit center notches 59 located on the top parallel edge of trapezoidal frame 21 (see FIG. 7) to the short column 49, and secure the bottom parallel edge of trapezoidal frame 22 to the narrow space between lower structure protrusions 52 and the fabric 15. Thus, the top parallel edge and bottom parallel edge are overlapingly joined to a partial section of the rigid upper structure and rigid lower structure, respectively, when assembling the lamp shade.

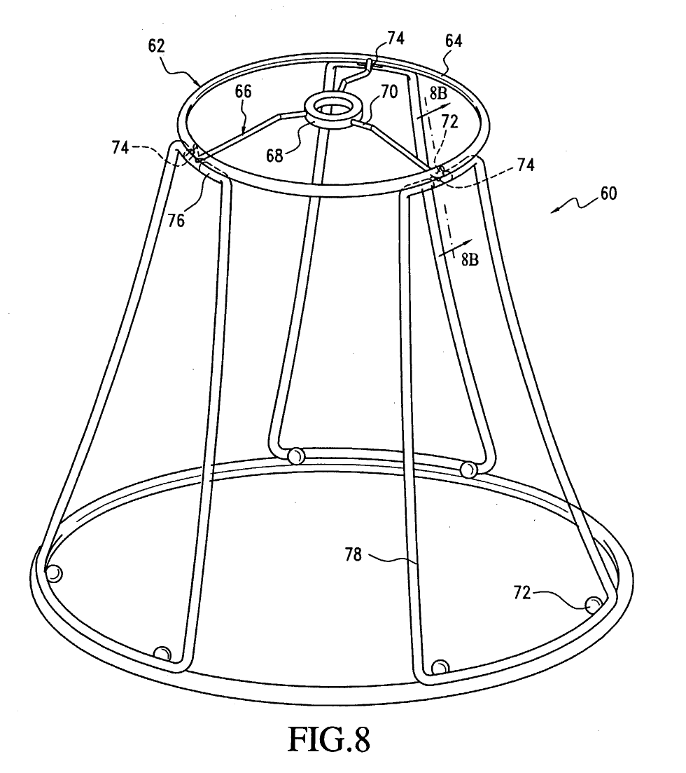

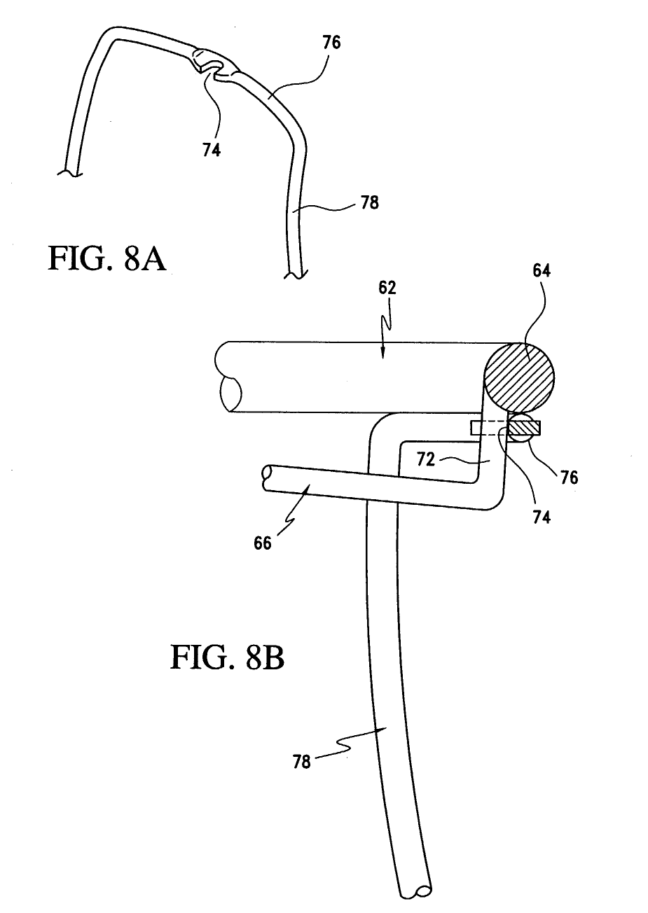

Referring now to FIG. 8 another embodiment of the collapsible lamp shade is illustrated, designated generally as 60. The figure shows the lamp shade 60 assembled; however, the fabric is not shown for the purposes of clarity. This is very similar to the embodiment of shown in FIGS. 5-7, i.e. it includes trapezoidal frames, each with a notch which has the same benefits as discussed above with respect to the previous embodiment. However, it includes a v-shaped portion on the angled arm that includes the short column, as will be discussed below.

As in the FIGS. 5-7 embodiment, this FIG. 8 embodiment includes a rigid upper structure assembly, designated generally in this figure as 62. As before, rigid upper structure assembly 62 includes a rigid upper structure 64; a plurality of angled arms 66 extending radially inwardly from the rigid upper structure 64; and, a central element 68 positioned at a central portion of the rigid upper structure assembly 62 for securing first ends 70 of the plurality of angled arms 66. The angled arms 66 have second ends that include short columns 72 that are angled upwardly. In this embodiment the short columns 72 are one “leg” of a v-shaped structure at the second end of each angled arm 66. The lower structure protrusions 72, i.e. lower structure attachment members, utilized are preferably spherical to provide easy engagement of the trapezoidal frames.

As in the previous embodiment, when being assembled, users engage the notch 74 on the side of a midsection of the top parallel edge 76 of the trapezoidal frame 78 with the short column 72 of each radial angled arm 66 such that the top parallel edge 76 of the trapezoidal frame 78 is positioned under the rigid upper structure 64. This can be clearly seen in FIGS. 8A and 8B.

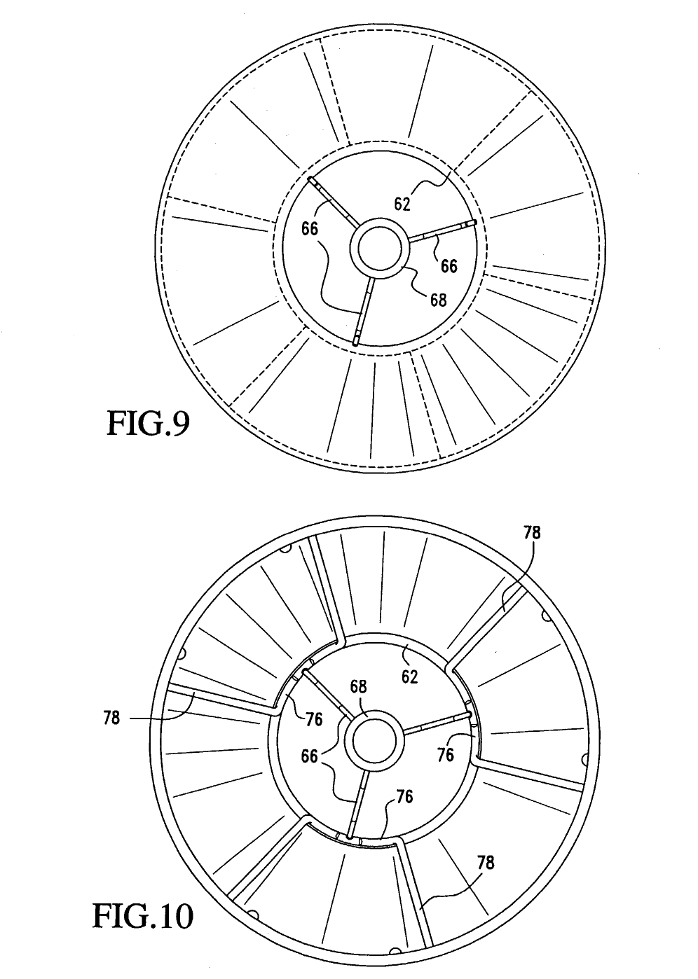

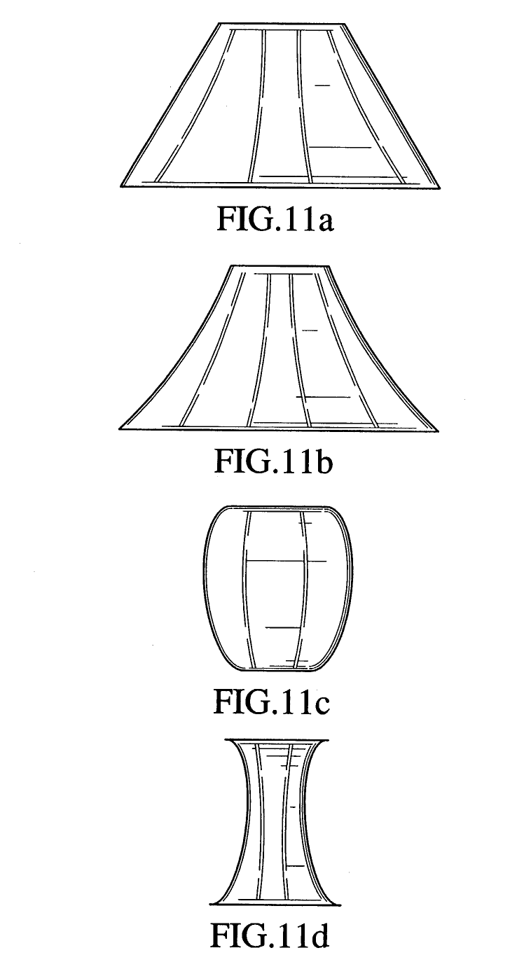

Thus, as can be seen in FIG. 9, the top parallel edge 76 of the trapezoidal frame 78 is hidden from view. Furthermore, the fabric material is held adjacent to the sides of the trapezoidal frame 78. This provides enhanced support of the fabric material. FIG. 10 is a bottom view of this embodiment.

Since the fabric material is so maintained adjacent to the sides of the trapezoidal frame 78 the present invention provides enhanced flexibility in allowing the designer to provide varying lamp shade shapes. This flexibility is illustrated in FIGS. 11a-11d which show various different lamp shade shapes, by way of illustration and not limitation, which may be utilized.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. A collapsible lamp shade, comprising:
a) a rigid upper structure;
b) a rigid lower structure;
c) a flexible fabric joining said rigid upper structure with said rigid lower structure;
d) a plurality of trapezoidal frames, each having a top parallel edge and a bottom parallel edge, said top parallel edge and bottom parallel edge being overlapingly joined to a partial section of said rigid upper structure and rigid lower structure, respectively, when assembling the lamp shade;
e) a plurality of angled arms having short columns on one end and radially connecting to said rigid upper structure; and,
f) a notch formed in a section of each said top parallel edges, wherein users can engage the notch with the short column of each angled radial arm when assembling the lamp shade.

2. The collapsible lamp shade of claim 1, further comprising:
a plurality of lower structure protrusions along the inner circumference of said rigid lower structure whereby users can secure the trapezoidal frames into position by fitting each of said bottom parallel edges in between a respective protrusion and the edge where the flexible fabric is connected to said rigid lower structure.

3. The collapsible lamp shade of claim 1, wherein each of said lower structure protrusions is substantially spherical.

4. The collapsible lamp shade of claim 1, wherein each notch is formed in a midsection of the top parallel edge.

5. The collapsible lamp shade of claim 1, wherein said lamp shade is formed having a relatively cylindrical design, said rigid upper structure being formed as a circular ring, said lower structure being formed as a circular ring, said top and bottom parallel edges of said basically trapezoidal frames being arc-shaped to conform with said rigid ring-shaped upper and lower structures when joining said trapezoidal frames to said rigid upper and lower structures during assembly of the lamp shade.

6. The collapsible lamp shade of claim 1, wherein each short column comprises a leg of a v-shaped structure at said second end of each angled arm.

7. A collapsible lamp shade, comprising:
a) a rigid upper structure assembly, comprising:
i. a rigid upper structure;
ii. a plurality of angled arms extending radially inwardly from said rigid upper structure, each angled arm having a first end and a second end; and,
iii. a central element positioned at a central portion of said rigid upper structure assembly for securing said first ends of said plurality of angled arms, said second ends of said angled arms having short columns being secured to said rigid upper structure, said short columns being angled upwardly;
b) a rigid lower structure including a plurality of lower structure attachment members;
c) a flexible fabric joining said rigid upper structure with said rigid lower structure; and,
d) a plurality of trapezoidal frames, each having a top parallel edge and a bottom parallel edge, said lower structure attachment members for engaging said bottom parallel edge upon assembly, said top parallel edge and bottom parallel edge being joined by side members, said top parallel edge having a notch formed in a section thereof, wherein users can engage the notch with the short column of each angled radial arm when assembling the lamp shade such that said top parallel edge of said trapezoidal frame is positioned under said rigid upper structure.

8. The collapsible lamp shade of claim 7, wherein each said notch is formed in a side of said top parallel edge.

9. The collapsible lamp shade of claim 7, wherein said lower structure attachment members comprise a plurality of lower structure protrusions along the inner circumference of said rigid lower structure whereby users can secure the trapezoidal frames into position by fitting each of said bottom parallel edges in between a respective protrusion and the edge where the flexible fabric is connected to said rigid lower structure.

10. The collapsible lamp shade of claim 7, wherein said rigid upper structure and said rigid lower structure are circular.

11. The collapsible lamp shade of claim 7, wherein each notch is formed in a midsection of the top parallel edge.

12. The collapsible lamp shade of claim 7, wherein each short column comprises a leg of a v-shaped structure at said second end of each angled arm.

13. A method for assembling a collapsible lamp shade, comprising:
a) providing a collapsible lamp shade, said collapsible lamp shade, comprising:
i. a rigid upper structure assembly, comprising:
1. a rigid upper structure;
2. a plurality of angled arms extending radially inwardly from said rigid upper structure, each angled arm having a first end and a second end; and,
3. a central element positioned at a central portion of said rigid upper structure assembly for securing said first ends of said plurality of angled arms, said second ends of said angled arms having short columns being secured to said rigid upper structure, said short columns being angled upwardly;
ii. a rigid lower structure including a plurality of lower structure attachment members;
iii. a flexible fabric joining said rigid upper structure with said rigid lower structure; and,
iv. a plurality of trapezoidal frames, each having a top parallel edge and a bottom parallel edge, said lower structure attachment members for engaging said bottom parallel edge upon assembly, said top parallel edge and bottom parallel edge being joined by side members, said top parallel edge having a notch formed in a section thereof;
b) engaging a notch of a first of said plurality of trapezoidal frames with a short column of a first of said plurality of said angled arms such that said top parallel edge of said trapezoidal frame is positioned under said rigid upper structure;
c) engaging a bottom parallel edge of said first trapezoidal frame with selected lower structure attachment members; and,
d) repeating steps b) and c) above for the remainder of said trapezoidal frames.

14. The method of claim 13, wherein said step of providing a collapsible lamp shade, comprises providing a collapsible lamp shade wherein each said notch is formed in a side of each respective top parallel edge.

15. The method of claim 13, wherein said step of providing a collapsible lamp shade, comprises providing a collapsible lamp shade wherein said lower structure attachment members comprise a plurality of lower structure protrusions along the inner circumference of said rigid lower structure whereby users can secure the trapezoidal frames into position by fitting each of said bottom parallel edges in between a respective protrusion and the edge where the flexible fabric is connected to said rigid lower structure.

16. The method of claim 13, wherein said step of providing a collapsible lamp shade, comprises providing a collapsible lamp shade wherein said rigid upper structure and said rigid lower structure are circular.

17. The method of claim 13, wherein said step of providing a collapsible lamp shade, comprises providing a collapsible lamp shade wherein each notch is formed in a midsection of the top parallel edge.
